(19) United States
(12) Patent Application Publication
(10) Pub. No.: US 2014/0246270 A1
(43) Pub. Date: Sep. 4, 2014

(54) AERIAL LIFT COMPRISING A WEIGHT MEASURING CELL

(71) Applicant: Haulotte Group, L'Horme (FR)

(72) Inventors: Sébastien Parot, Saint Martin La Plaine (FR); Nicolas Bonnefoy, Saint Chamond (FR)

(73) Assignee: Haulotte Group, L'Horme (FR)

(21) Appl. No.: 14/193,449

(22) Filed: Feb. 28, 2014

(30) Foreign Application Priority Data
Mar. 1, 2013 (FR) 1351845

(51) Int. Cl. B66F 11/04

(52) U.S. Cl. CPC B66F 11/04
USPC 182/63.1

(57) ABSTRACT

An aerial lift comprises a chassis equipped with movement means for moving on the surface of the ground, a platform, means for elevating the platform relative to the chassis, and a cell for measuring the weight of the load supported by the platform, said cell having a body supporting at least one sensor and extending along a longitudinal axis. A geometric enclosure surface of the body, around the longitudinal axis, converges toward that axis, and the force measuring cell is embedded, along an embedding axis, in a housing defined by a surface with a shape complementary to the geometric enclosure surface, provided in a support structure of the platform.

### FIELD

An aerial lift is disclosed that is equipped with a weight measuring cell for a load supported on the platform of the lift.

### BACKGROUND

An aerial lift includes a chassis equipped with movement means for moving on the surface of the ground, a platform for supporting loads or people, a mast, and means for elevating the platform relative to the chassis. In the field of lifting loads and people, it is important to be able to measure the vertical forces applied on the platform. In fact, this makes it possible to avoid an overload in to guarantee operator safety. In practice, if the measured load exceeds the authorized limit, operation of the lift is blocked. Furthermore, the regulations require that the lifted load must be measured with a margin of error of approximately 20%. Although this margin of error a priori seems large, it is nevertheless difficult to achieve this precision for weighing cells integrated into worksite vehicles. In fact, weighing cells are commonly mounted on the outside of the lift, which requires performing surface treatments at the contact area and exposing the force measuring cell to a worksite environment. It may thus be deteriorated by dust or other impurities.

To that end, known from U.S. Pat. No. 4,530,245 is a cell making it possible to measure the deformation within a structure. This cell is designed to be integrated into a housing within any structure. It has a globally cylindrical shape and has a diameter slightly larger than that of the housing provided in the structure. Thus, it is necessary to impact the force measuring cell so as to cause it to progress in the housing. This assembly method is relatively restrictive, since it most often requires an additional energy contribution and the force measuring cell is made unable to be disassembled. Furthermore, the blows dealt to the force measuring cell during the impact cause residual stresses within the force measuring cell, which makes the force measurement imprecise.

### SUMMARY

The aerial lift disclosed herein more particularly aims to resolve these drawbacks wherein integration of a measuring cell for measuring the weight of the load supported by the platform is facilitated and does not cause residual stresses.

To that end, an aerial lift is disclosed comprising a chassis equipped with movement means for moving on the surface of the ground, a platform, means for elevating the platform relative to the chassis, and a cell for measuring the weight of the load supported by the platform, said cell having a body supporting at least one sensor and extending along a longitudinal axis. In some embodiments, a geometric enclosure surface of the body, around the longitudinal axis, converges toward the axis, and the force measuring cell is embedded, along an embedding axis, in a housing defined by a surface with a shape complementary to the geometric enclosure surface, provided in a support structure of the platform.

With the disclosed aerial lift, it is possible to assemble or disassemble a force measuring cell on an aerial lift simply, without the force measuring cell undergoing stresses during the assembly thereof.

The aerial lift may incorporate one or more of the following features, in any technically allowable combination:
The geometric enclosure surface is a frustoconical surface.
The geometric enclosure surface is a surface with a transverse, ellipsoid or polygonal section.
The body of the measuring cell comprises one or more ribs that extend parallel to the longitudinal axis and are regularly distributed around the latter, and in that the outer surfaces of the ribs define the geometric enclosure surface of the body.
The body of the cell is hollow and comprises, on the inside, at least two supports that are diametrically opposite and between which a sensor is fastened.
The sensor is a strain gauge.
The cell further comprises a ring that is positioned around the end of the body of the cell, on the divergent side of the geometric enclosure surface of the body.
The ring is fastened to the support structure using screws, the tightening play of the screws, along the embedding axis, being greater than 2 mm.
The measuring cell is made from a material having heat expansion properties similar to those of the material of the support structure.

### BRIEF DESCRIPTION OF THE DRAWINGS

Other advantages will appear more clearly, in light of the following description of one embodiment of an aerial lift according to its principle, provided solely as an example and done in reference to the appended drawings, in which:

FIG. 1 is a perspective view of a lift according to one embodiment,

FIG. 2 is an enlarged view in an exploded configuration of inset II of FIG. 1,

FIG. 3 is a detailed view along arrow III of FIG. 1,

FIG. 4 is a cross-section along line IV-IV of FIG. 2,

FIG. 5 is an enlarged cross-section along line V-V of FIG. 3,

FIG. 6 is a detailed view along line VI-VI of FIG. 5.

### DETAILED DESCRIPTION

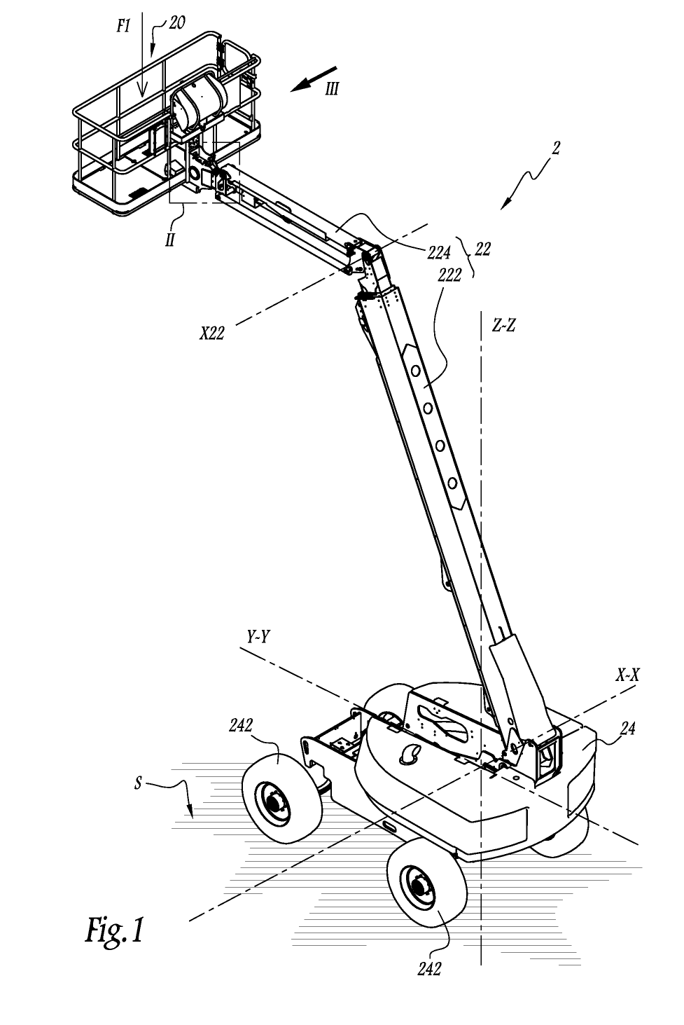

FIG. 1 shows an aerial lift. This aerial lift 2 comprises a chassis 24 equipped with movement means 242 for moving on the surface S of the ground. In this example, these movement means are wheels 242, but they may also be tracks. An axis Y-Y is defined as the axis defining the direction of movement in a straight line of the chassis 24 relative to the ground. The aerial lift 2 includes a platform 20 for supporting a load or people, capable of moving vertically, along a vertical axis Z-Z, relative to the chassis 24.

To ensure the movement of the platform 20, the aerial lift 2 comprises a mast 22 that is attached to the chassis 24 by a pivot link pivotable around an axis X-X that is perpendicular to the axes Z-Z and Y-Y. The mast 22 comprises two arms articulated around an axis X22 substantially parallel to the axis X-X and which are set in motion by cylinders. This technique for moving the platform is known; the cylinders are therefore not shown in figures. A first arm 222 of the mast 22 is articulated on the chassis 24, and a second arm 224 of the mast 22, pivotably connected with the first arm 224 around the axis X22, supports the platform 20.

In the usage configuration, a vertical force F1 applied on the floor of the platform 20 is diagrammatically defined as the force that must be measured precisely in order to avoid an overload on the platform 20. The lift 2 therefore comprises a force measuring cell that is situated as close as possible to the platform 20, so as to minimize the influence of the weight of the mechanical structure of the lift 2 on the measurement and to reflect the vertical force F1 applied on the platform 20 faithfully. The vertical force F1 represents the weight of a load supported by the platform 20.

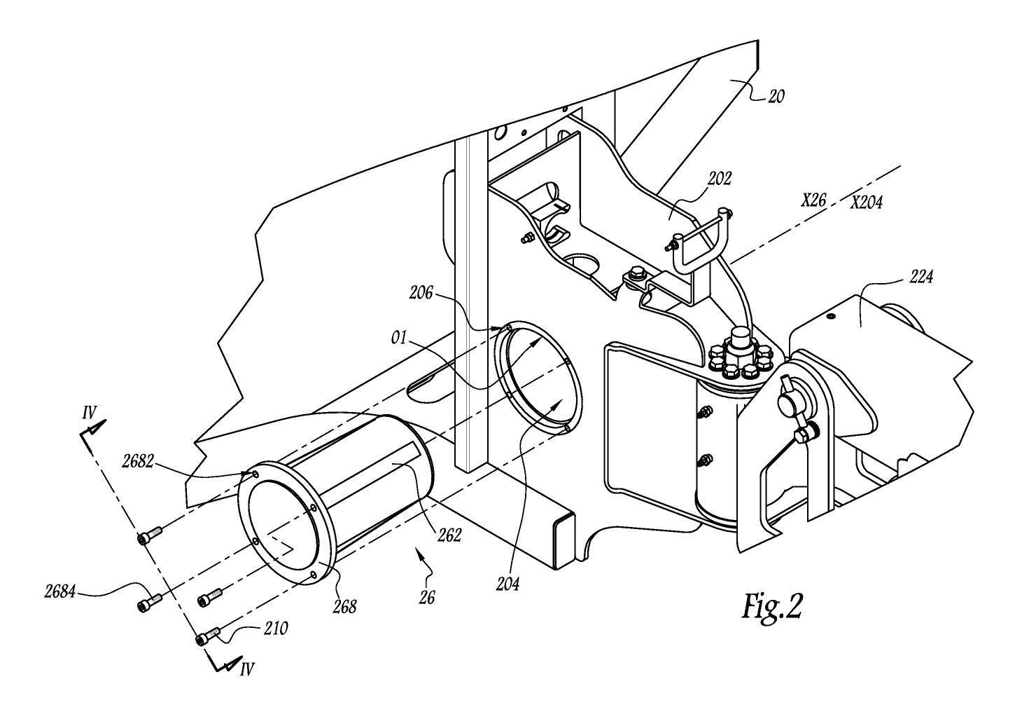

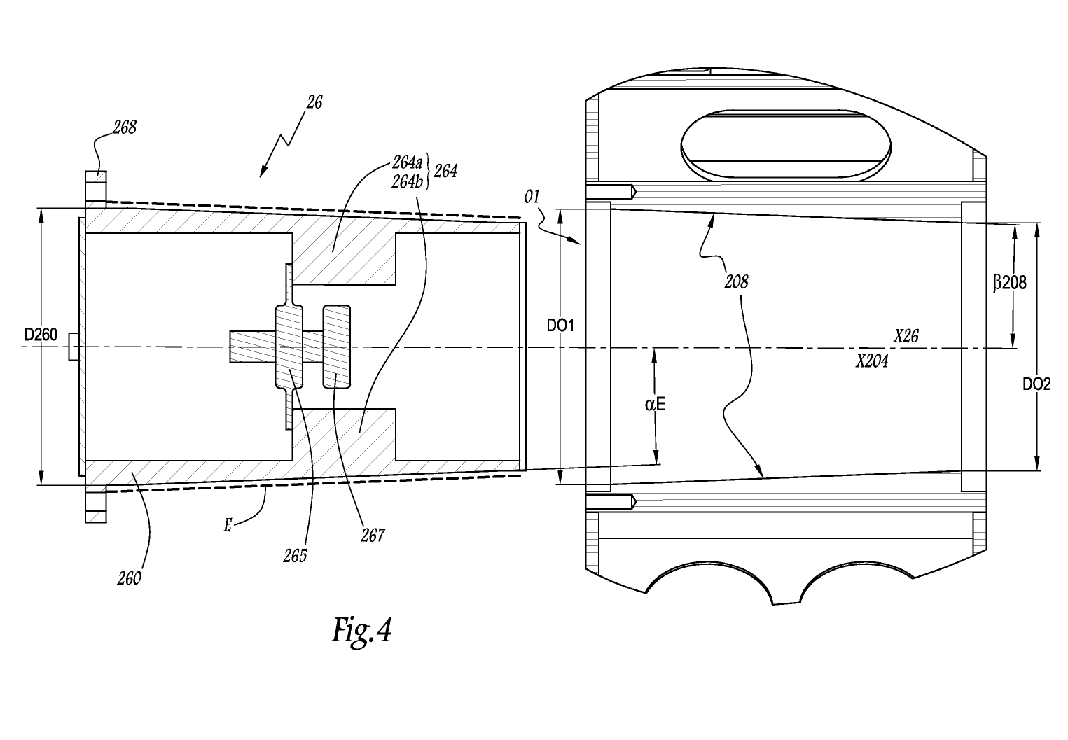

As shown in FIGS. 2 to 6, the aerial lift 2 comprises a measuring cell 26 which, for clarity of the drawing, is shown on the outside of the platform 20. This measuring cell 26 makes it possible to measure the weight applied on the platform 20 of the aerial lift 2. It includes a hollow body 260 that extends along a longitudinal axis X26. For better clarity of the description, a geometric enclosure surface E of the body 260 of the cell 26 is defined around the axis X26. This geometric enclosure surface E is shown in dotted lines in FIG. 4. It is imaginary and defined for explanatory purposes. As illustrated in FIG. 2, the body 260 of the cell 26 has a generally circular section, centered on the axis X26, and includes four longitudinal ribs 262 regularly distributed around the axis X26 and each offset by 45° relative to the axis Z-Z and around the axis X26. The geometric enclosure surface E of the body 260 of the cell therefore rests on the outer surface 2622 of the ribs 262. The ribs 262 have an outer slope inclined relative to the longitudinal axis X26. Thus, the geometric enclosure surface E of the body 260 of the cell 26, around the longitudinal axis X26, converges toward the axis X26 and therefore has a frustoconical shape. The outer surfaces 2622 of the ribs 262 are frustoconical portions. The geometric enclosure surface E is flush with the surfaces 2622 of the ribs 262, which it connects to each other, around the axis X26.

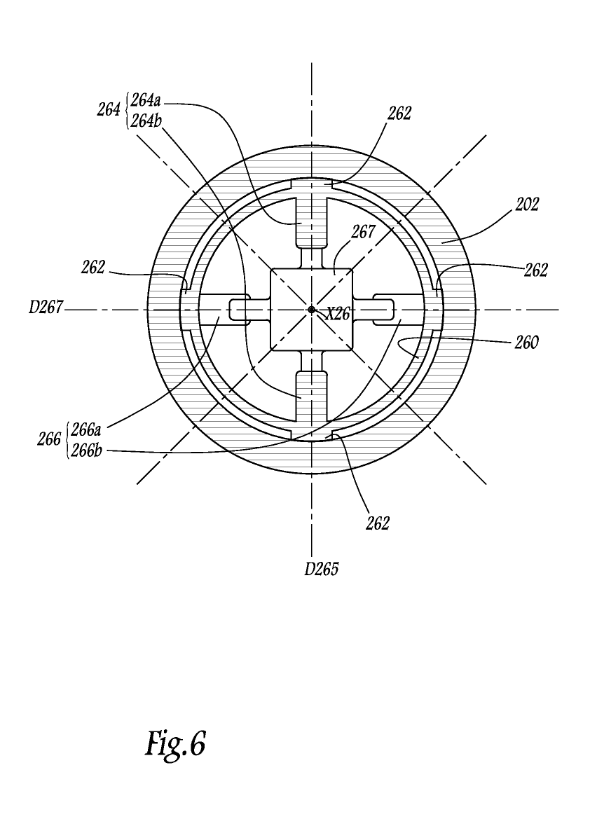

As shown in FIG. 6, the body 260 of the cell 26 includes, on the inside, two pairs of supports 264 and 266. The first pair 264 is formed by two supports 264a and 264b that are positioned diametrically opposite one another inside the body 260. The second pair 266 is made up of two other supports 266a and 266b that are also positioned diametrically opposite one another and that are offset by 90° around the axis X26 from the first pair 264. Positioned between each pair of supports 264 and 266 are sensors which, in the example, are strain gauges 265 and 267. The gauge 265 extends from the support 264a to the support 264b and the gauge 267 extends from the support 266a to the support 266b. The gauges 265 and 267 are rigidly fastened to the supports 264 and 266, respectively, in particular by screwing. The supports 264 and 266 as well as the gauges 265 and 267 are each radially aligned with a rib 262. D265 and D267 denote the axes along which the gauges 265 and 267 extend, respectively. The supports 264, the strain gauge 265 and two opposite ribs 262 are therefore aligned along the axis D265. Similarly, the supports 266, the strain gauge 267 and two opposite ribs 262 are aligned along the axis D267. The forces applied by the structure 202 on the cell 26 act at the ribs 262. These forces are therefore passed on directly at the supports 264 and 266 and, consequently, the gauges 265 and 267. When the axes D265 and D267 are brought into a same plane transverse to the axis X26, they are perpendicular.

The strain gauges 265 and 267 are therefore arranged perpendicular to one another, which makes it possible to measure several components of the strain wrench. This thereby provides better knowledge of the strain condition of the cell 26, which makes it possible to deduce the force F1 applied on a platform 20 more precisely. Strain gauges 265 and 267 being known in themselves, they are shown in FIGS. 4, 5 and 6 as parallelepiped blocks.

On the side opposite the tip of the imaginary cone, i.e., the divergent cone of the geometric enclosure surface E relative to the axis X26, this measuring cell 26 comprises a ring 268 positioned at the end and around the body 260 of the cell 26 and on which four piercings 2682 are regularly distributed around the central axis X26, with the understanding that the geometric enclosure surface E only surrounds the body 260 and not the ring 268. The measuring cell 26 further comprises four screws 2684 that are inserted into the piercings 2682.

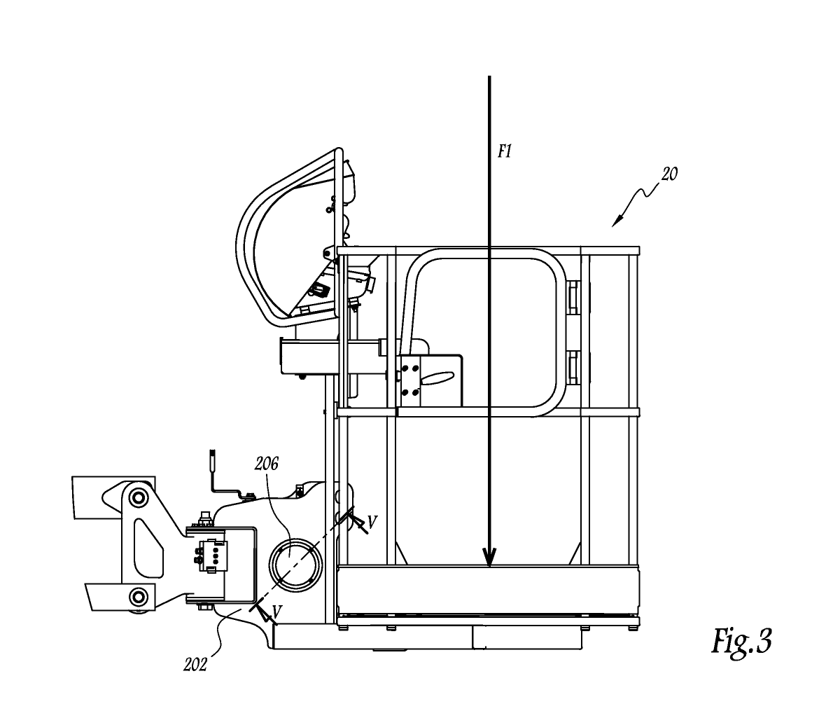

As illustrated in FIGS. 2 and 3, the platform 20 comprises a support structure 202. The support structure 202 is situated in the lower part of the platform 20 and is secured to the arm 224 of the mast 22 by a bolted assembly. In the support structure 202, a housing 204 is hollowed in a direction X204, parallel to the axis X-X. In the assembled configuration of the cell 26 on the structure 202, the axis X204 and the axis X26 are combined. The housing 204 has an opening O1 and a profile complementary to that of the geometric enclosure surface E of the body 260 of the measuring cell 26, i.e., a frustoconical shape. More specifically, the housing 204 has an inner surface 208 converging from the opening O1 toward the axis X204, which is inclined identically to the slope of the ribs 262 of the body 260 of the measuring cell 26. Additionally, the apical half-angle G_{E} of the geometric enclosure surface E is equal to the apical half-angle β₂₀₈ of the surface 208. In practice, the value of these angles is chosen between 1° and 10°. Likewise, the maximum diameter D260 of the body 260, with the exception of the ring 268, is comprised between the maximum diameter DO1 and the minimum diameter DO2 of the opening O1. The inner surface 200 is therefore complementary to the geometric enclosure surface E of the body 260 of the measuring cell 26.

In the assembled configuration of the cell 26 in the structure 202, the strain gauges 265 and 267 are not in contact with the inner surface 208 of the housing 204, since they are fastened on the supports 264 and 266. This thereby avoids deterioration of the strain gauges during assembly, and therefore distorted measurements. On the outside and on the periphery of the opening O1 of the housing 204, there are four blind tappings 206 whereof the screw pitch is complementary to the outer threading of the screws 2684 and which are also regularly distributed around the axis X204.

The housing 204 is hollowed as close as possible to the platform 20 so as to minimize the influence of the weight of the mechanical structure of the lift 2 on the measurement.

Furthermore, using a frustoconical shape for the measuring cell 26 allows easier embedding and minimized radial play between the cell 26 and the housing 204 and relative to the axis X204. This also makes it possible to eliminate axial stop means, along the axis X204 of the measuring cell 26 at the axial end opposite the ring 268. The measuring cell 26 is made from a material, such as steel, having mechanical properties similar to those of the structure 202. Thus, the measuring cell 26 does not constitute a weak link in the structure 202 and faithfully reflects the deformations thereof. As a result, the vertical force measured is close to reality. In practice, the margin of error obtained for the measurement of a vertical force with a measuring cell integrated in this way is 10%.

One can also see a tightening play J1, along the embedding axis X204, between the measuring cell 26 and the structure 202. This play J1 is greater than 2 mm, so that the outer surfaces of the ribs 262 of the cell 26 and the inner surface 208 of the housing 204 are in perfect contact despite the machining allowances of the parts and therefore, the measured force is representative of the vertical force F1 applied on the platform 20. During the assembly, the operator is called upon to embed the measuring cell 26, along the embedding axis X204, in the opening O1 of the housing 204 provided for that purpose. In the case of a cell with a circular section, the operator must rotate the cell 26 around the axis X26 so that the piercings 2682 and the tappings 206 are aligned, along an axis parallel to the axis X204. Once the cell 26 is embedded, the screws 2684 should be screwed through the piercings 2682 and into the tappings 206, so as to fasten the force measuring cell 26 on the structure 202. The number of screws 2684 used depends on the tightening force that one wishes to apply between the measuring cell 26 and the structure 202, the aim being to be able to assemble the measuring cell 26 quickly, while ensuring that it is securely fastened.

Conversely, when the cell 26 is removed from the structure 202, it is necessary to unscrew the screws 2684, then to remove the cell 26 outside the structure 202.

The integration of the measuring cell 26 into the platform 20 therefore does not add any bulk to the lift 2 and can be done by an operator without any specialized tools.

As one alternative that is not shown, it is also possible to integrate the measuring cell 26 into the mast 22. This nevertheless means increasing the influence of the weight of the mechanical structure of the lift 2 in the force measured by the cell, and therefore decreasing the measuring precision of the force F1.

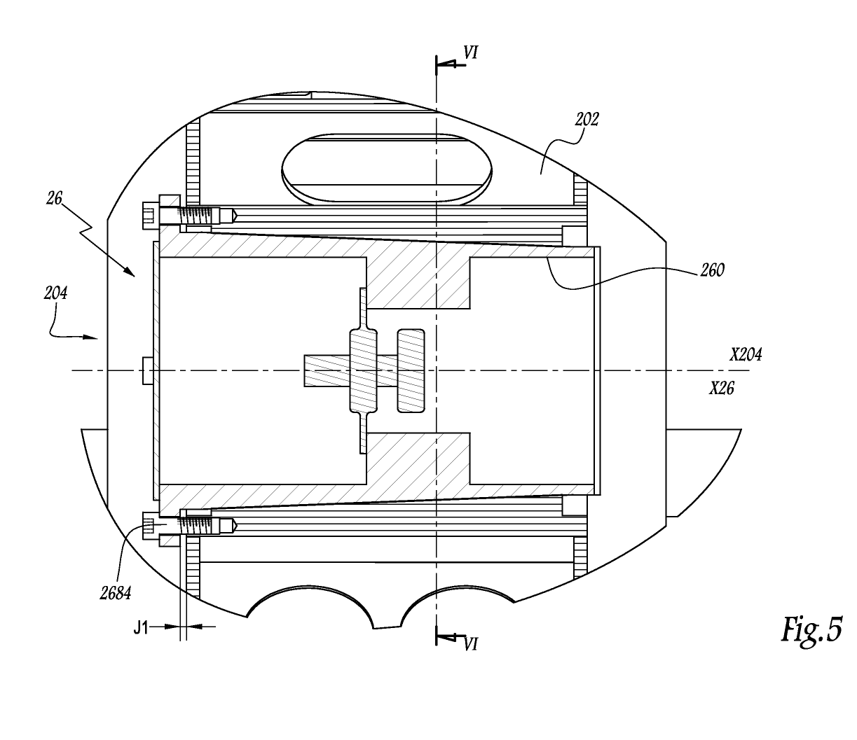

As shown in FIG. 5, the measuring cell 26 crosses the housing 204, but it is possible to consider the housing 204 being of the blind type.

In this assembly, the measuring cell 26 is fastened on the structure 202 using screws. It is also possible to immobilize the measuring cell 26 using a mechanical valve or a pin.

It is also possible to consider using a measuring cell working with a different deformation measurement technology.

Lastly, the measuring cell 26 has a circular section, but it is also possible to use a polygonal section, an ellipsoid section, or any other suitable shape. In the case of a polygonal section, the geometric enclosure surface of the body 260 of the cell is then a pyramid portion with a polygonal base.

Alternatively, the gauges 265 and 267 are glued or welded on the supports 264 and 266.

The products, and methods of the appended claims are not limited in scope by the specific products and methods described herein, which are intended as illustrations of a few aspects of the claims and any products and methods that are functionally equivalent are intended to fall within the scope of the claims. Various modifications of the products and methods in addition to those shown and described herein are intended to fall within the scope of the appended claims. Further, while only certain representative features and method steps disclosed herein are specifically described, other combinations of the features and method steps also are intended to fall within the scope of the appended claims, even if not specifically recited. Thus, a combination of steps, elements, components, or constituents may be explicitly mentioned herein; however, other combinations of steps, elements, components, and constituents are included, even though not explicitly stated. The term “comprising” and variations thereof as used herein is used synonymously with the term “including” and variations thereof and are open, non-limiting terms. Although the terms “comprising” and “including” have been used herein to describe various embodiments, the terms “consisting essentially of” and “consisting of” can be used in place of “comprising” and “including” to provide for more specific embodiments and are also disclosed.

1. An aerial lift, comprising:
a chassis equipped with movement means for moving on the surface of the ground;
a platform;
means for elevating the platform relative to the chassis; and
a cell for measuring the weight of the load supported by the platform, said cell having a body supporting at least one sensor and extending along a longitudinal axis,
wherein a geometric enclosure surface of the body, around the longitudinal axis, converges toward that axis, and the cell is embedded, along an embedding axis, in a housing defined by a surface with a shape complementary to the geometric enclosure surface, provided in a support structure of the platform.

2. The aerial lift according to claim 1, wherein the geometric enclosure surface is a frustoconical surface.

3. The aerial lift according to claim 1, wherein the geometric enclosure surface is a surface with a transverse, ellipsoid or polygonal section.

4. The aerial lift according to claim 1, wherein the body of the measuring cell comprises one or more ribs that extend parallel to the longitudinal axis and are regularly distributed around the longitudinal axis, and wherein the outer surfaces of the ribs define the geometric enclosure surface of the body.

5. The aerial lift according to claim 1, wherein the body of the cell is hollow and comprises, on the inside, at least two supports that are diametrically opposite and between which a sensor is fastened.

6. The aerial lift according to claim 5, wherein the sensor is a strain gauge.

7. The aerial lift according to claim 4, wherein the cell further comprises a ring that is positioned around the end of the body of the cell, on the divergent side of the geometric enclosure surface of the body.

8. The aerial lift according to claim 7, wherein the ring is fastened to the support structure using screws, and wherein the tightening play of the screws, along the embedding axis, is greater than 2 mm.

9. The aerial lift according to claim 1, wherein the measuring cell is made from a material having heat expansion properties similar to those of the material of the support structure.
